(19) United States
(12) Patent Application Publication
(10) Pub. No.: US 2019/0093692 A1
(43) Pub. Date: Mar. 28, 2019

(54) REPARATURANORDNUNG UND GASTURBINE

(71) Applicant: GENERAL ELECTRIC COMPANY, Schenectady, NY (US)

(72) Inventors: Szymon JARZEBOWSKI, Warsaw (PL); Marek WOJCIECHOWSKI, Warsaw (PL); Krzysztof DYNAK, Warsaw (PL); Damian WOLFF, Warsaw (PL)

(21) Appl. No.: 16/145,296

(22) Filed: Sep. 28, 2018

(30) Foreign Application Priority Data
Sep. 28, 2017 (EP) 17461614.4

(51) Int. Cl. F16B 31/02; B23P 6/00

(52) U.S. Cl. CPC F16B 31/02; F01D 25/24; B23P 6/002

(57) ABSTRACT

The invention relates to a repair arrangement for a housing component of a gas turbine, wherein the housing component has at least one crack and at least one torque screw is inserted into the housing component to exert a force on the at least one crack. The invention further relates to a gas turbine having such a repair arrangement.

### FIELD OF THE INVENTION

The invention relates to a repair arrangement for a gas turbine and a gas turbine having such a repair arrangement

In a gas turbine, air in a compressor is compressed and mixed with fuel in a combustion chamber to produce hot combustion gases. The gases have energy withdrawn from them in a high-pressure turbine that drives the compressor and a low-pressure turbine that drives a fan in a turbofan engine or an external shaft for marine and industrial applications. The high-pressure and low-pressure turbines are accommodated in a housing.

Such gas turbines are exposed to high mechanical loads during operation. In particular, vibrations can lead to material fatigue and thus to the formation of cracks in the housing. In addition, thermal stresses are added due to the starting and stopping of the gas turbine. These temperature fluctuations and the associated expansion and contraction of the housing can contribute to the formation of cracks and, in particular, promote the propagation of cracks that have already formed.

If a crack in the housing is detected in the course of the regular inspection, the affected housing component usually needs to be replaced immediately. This can lead to breakdowns and delays which can cost the operator a considerable amount of money.

### BACKGROUND OF THE INVENTION

Various methods are known to inhibit the propagation of cracks that have already occurred, thus maintaining the operability of a gas turbine with a crack in the housing, at least for a short time.

For example, relief holes can be made at the tip of the crack to block the further propagation of the crack. In addition, the use of fillers, tack welds or reinforcing elements applied over the crack mounted is known.

U.S. Pat. No. 6,071,051 A describes a method for repairing cracks in which a screw is inserted into a component with a crack, whereby the crack is clamped.

In the known methods, however, precisely predetermined forces can only be exerted on the crack with difficulty. As a result, additional stresses can be introduced to the material of the housing component which counteract the desired extension of the life.

### BRIEF SUMMARY OF THE INVENTION

The object of this invention is therefore to provide a repair arrangement and a gas turbine in which the propagation of cracks can be reliably inhibited and the life of a housing component of the gas turbine is safely extended.

The object is achieved by a repair arrangement having the features of claim 1 and a gas turbine having the features of claim 8 or 9.

In such a repair arrangement for a housing component of a gas turbine, the housing component has at least one crack. At least one torque screw is inserted into the housing component to exert a force on the at least one crack.

Torque screws have a variable force transmission between a screw head and a shaft of the screw. If a predetermined tightening torque is reached, a connecting element between the screw head and the shaft is released such that the torque screw cannot be tightened further. As a result, a precisely defined force can be exerted on the crack, without introducing unnecessary additional stresses to the material of the housing component.

Thus, on the one hand, crack propagation is reliably inhibited and, on the other hand, a particularly long life of the housing component thus repaired is ensured.

In an embodiment of the invention, the at least one torque screw is made of stainless steel or nickel-based steel.

This ensures that the at least one torque screw has the necessary strength to exert the desired force on the crack. At the same time, possible electrochemical corrosion between the torque screw and the conventional materials of the housing components is thus avoided.

In a further embodiment of the invention, a material of the at least one torque screw has a yield strength that is at least twice the yield strength of the material of the housing component.

This ensures that the torque screw does not become deformed itself on reaching the desired tightening torque, but rather can transfer the set force completely to the material of the housing component.

For example, the yield strength of spheroidal graphite iron, which is often used for the housings, is between 310 MPa and 670 MPa. Depending on the alloy used, the yield strength of the torque screw material should therefore be more than 620 MPa and up to more than 1,340 MPa.

In a further embodiment of the invention, a longitudinal extension direction of the at least one torque screw extends normally to a propagation plane of the at least one crack.

In such an embodiment, therefore, the shaft of the torque screw runs perpendicular to the propagation plane of the crack and the torque screw prevents or reduces the opening of the crack under load and thus inhibits crack growth.

In a further embodiment of the invention, the at least one torque screw is inserted into a borehole of the housing component, which has a receptacle for a screw head of the torque screw.

The repair arrangement therefore does not affect the geometry of the housing component, since the torque screw is completely countersunk into the housing component.

In a further embodiment of the invention, the housing component is one housing half of a gas turbine housing.

In the area in which bolt connections between the housing parts weaken flanges, the housing halves of gas turbine housings are susceptible to the formation of cracks, which may thus lead to breakdowns. The associated costs can be reduced particularly reliably by such a repair arrangement.

In a further embodiment of the invention, the crack extends from a horizontal connecting edge in the installed position of the housing component as far as a second housing half.

Such connecting edges are focal points of crack formation, such that the mentioned benefits are particularly relevant here.

The invention further relates to a gas turbine having a housing component, wherein the housing component includes at least one crack and at least one torque screw is inserted into the housing component to exert a force on the at least a crack.

The advantages mentioned with reference to the repair arrangement also apply to the gas turbine in its entirety.

In addition, the invention relates to a gas turbine with a repair arrangement of the described type.

### BRIEF DESCRIPTION OF THE DRAWING

The invention is described in more detail below with reference to the drawing, in which

FIG. 1 shows a schematic representation of a housing component of a gas turbine with a crack;

FIG. 2 shows a schematic sectional view of an exemplary embodiment of a repair arrangement according to the invention; and

FIG. 3 shows a schematic plan view of an exemplary embodiment of a repair arrangement according to the invention.

### DETAILED DESCRIPTION

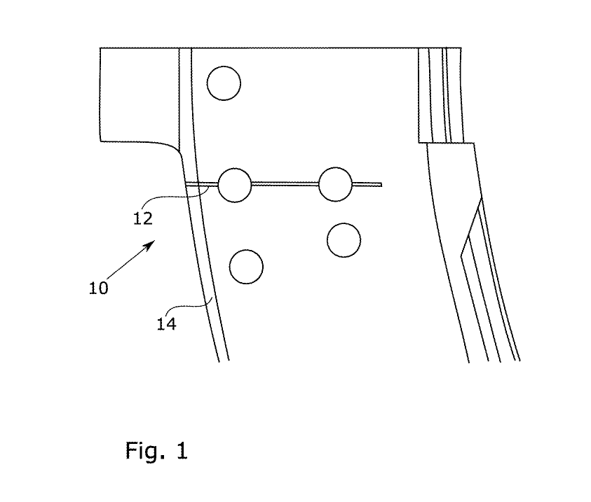

FIG. 1 shows a housing component 10 for a gas turbine. The housing component 10 is a part of a turbine housing, for example, a housing half, which consists of a ductile cast-iron alloy, preferably spheroidal graphite iron.

Due to the vibration load during operation of the gas turbine, a crack 12 has formed in the housing component 10, which crack extends away from a connecting flange 14 into the interior of the housing component 10. In the example shown, a crack forms in a plane of the connecting flange 14 which is weakened by boreholes for the bolted connection of the housing components 10.

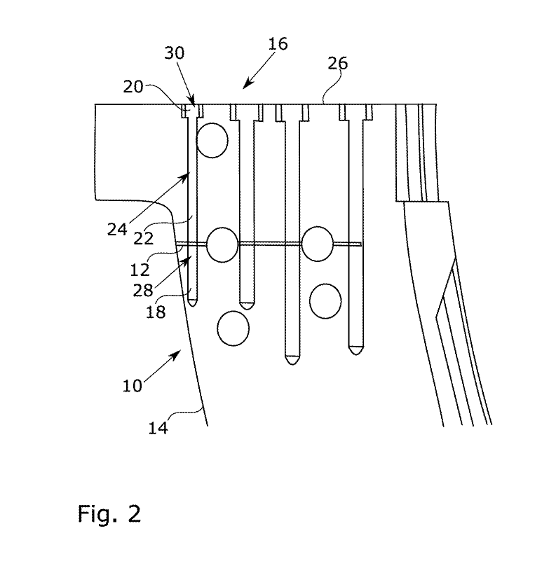

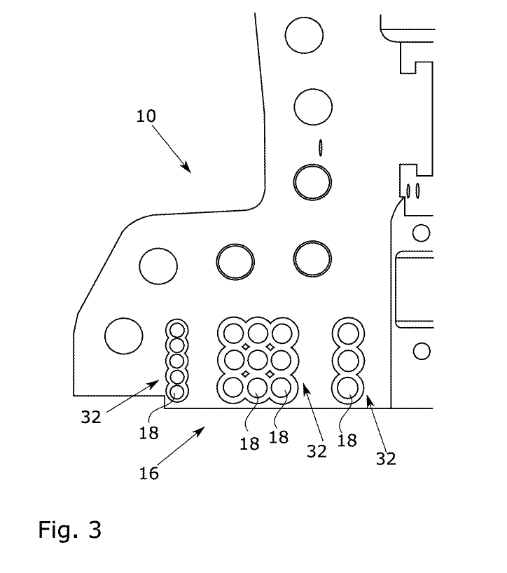

For safety reasons, such a damaged housing component 10 must generally be discarded. Nevertheless, in order to allow the safe continued operation of the gas turbine, at least temporarily, further propagation of the crack 12 can be inhibited by means of the repair arrangement 16 shown in FIGS. 2 and 3. In this way, it is at least possible, for example, that such a weakened gas turbine can continue to be operated for one or more maintenance intervals.

In order to secure the crack 12, a plurality of torque screws 18 are mounted substantially perpendicular to the propagation plane of the crack 12 in the housing component 10. In the interest of clarity, not all such torque screws are shown in the figures.

The torque screws 18 have a variable force transmission between a screw head 20 and a shaft 22 of the torque screw 18. If a predetermined tightening torque is reached, a connecting element between the screw head 20 and the shaft 22 is released such that the torque screw 18 cannot be tightened further. This allows a well-defined force to be exerted on the crack 12.

The material of the torque screws 18 has a yield strength that is at least twice the yield strength of the material of the housing component 10.

This ensures that the torque screw itself does not become deformed on reaching the desired tightening torque, but rather can transfer the set force completely to the material of the housing component 10.

For example, the yield strength of spheroidal graphite iron is between 310 MPa and 670 MPa. Depending on the alloy used, the yield strength of the torque screw material should therefore be more than 620 MPa and up to more than 1,340 MPa. For example, stainless steel or nickel-based steel may be used for the torque screws 18.

The torque screws 18 are inserted into boreholes 24 in the housing component 10. These extend far enough from an edge 26 of the housing component 10 that around half of the shaft 22 extends beyond the crack 12, such that a uniform force is exerted on the crack 12.

The boreholes have a shaft area 28 and a comparatively wider head area 30. The shaft area 28 accommodates the shaft 22 of the torque screws 18, while the head 20 of the torque screws is countersunk into the head area 30 of the boreholes 24. Thus, the head 20 of the torque screws 18 is flush with the edge 26 of the housing component 10.

As shown in the plan view of FIG. 3, the torque screws 18 are arranged in groups 32. This ensures that a uniform force is exerted over the entire crack 12 and further propagation of the crack is prevented.

What we claim is:

1. Repair arrangement for a housing component of a gas turbine, wherein the housing component has at least one crack and at least one torque screw is inserted into the housing component to exert a force on the at least one crack.

2. Repair arrangement according to claim 1, wherein the at least one torque screw is made of stainless steel or nickel-based steel.

3. Repair arrangement according to claim 1, wherein the material of the at least one torque screw has a yield strength which is at least twice the yield strength of the material of the housing component.

4. Repair arrangement according to claim 1, wherein a longitudinal extension direction of the at least one torque screw is substantially perpendicular to a propagation plane of the at least one crack.

5. Repair arrangement according to claim 1, wherein the at least one torque screw is inserted in a borehole of the housing component, which has a receptacle for a screw head of the torque screw.

6. Repair arrangement according to claim 1, wherein the housing component is one housing half of a gas turbine housing.

7. Repair arrangement according to claim 6, wherein the crack extends from a horizontal connecting edge in the installed position of the housing component as far as a second housing half.

8. Gas turbine with a housing component, wherein the housing component has at least one crack and at least one torque screw is inserted into the housing component to exert a force on the at least one crack.

9. Gas turbine with a repair arrangement according to claim 1.
